(19) United States
(12) Patent Application Publication
(10) Pub. No.: US 2007/0241625 A1
(43) Pub. Date: Oct. 18, 2007

(54) BRUSHLESS MOTOR

(76) Inventor: Takahiro Terauchi, KIRYU-SHI (JP)

Correspondence Address: KENYON & KENYON LLP, ONE BROADWAY, NEW YORK, NY, 10004, US

(21) Appl. No.: 11/587,786

(22) PCT Filed: Apr. 26, 2005
(86) PCT No.: PCT/JP05/07897

§ 371 Date: Oct. 25, 2006

(30) Foreign Application Priority Data
Apr. 30, 2004 (JP) 2004-135780

(51) Int. Cl. H02K 11/00; H02K 5/00; H02K 47/00

(52) U.S. Cl. 310/68 B; 310/71; 310/89; 310/91; 324/207.12; 310/112

(57) ABSTRACT

A brushless motor includes: a housing; a bracket which covers over an opening of the housing; a resolver case which houses a resolver stator of a resolver, and which is attached to the bracket; claw portions which are respectively provided with adjusting claws extending along a direction substantially parallel to an axis of a rotor, and which are provided at the resolver case; and a resolver terminals for acquiring signals from the resolver stator, which are provided at the resolver case, wherein a through-holes into which the claw portions are respectively inserted are formed in the bracket.

### CROSS-REFERENCE TO RELATED APPLICATIONS

This application is a National Phase Application of PCT/JP2005/007897 filed on Apr. 26, 2005, and claims priority to Japanese Patent Application No. 2004-135780, filed Apr. 30, 2004, the content of each of which is incorporated herein by reference.

### BACKGROUND ART OF THE INVENTION

A brushless motor which causes a rotor having magnets to rotate by applying a current to a stator having a magnetic coil is a rotating electrical machine. With the brushless motor, the rotation angle of the rotor is measured by a resolver, and the energization control is performed based on a result of the measurement by the resolver.

The resolver measures changes in the gap permeance between the resolver rotor and the resolver stator based on a sinusoidal waveform in association with a change in the rotation angle of the resolver rotor, and measures the rotation angle of the resolver rotor. However, it is known that the result of the measurement is greatly influenced by the dimensional accuracy, the mounting accuracy, or the like. Therefore, various mounting structures for the resolver have been developed before.

For example, in one of the brushless motors, a case of the brushless motor supports the resolver stator by pushing the resolver stator to the case by meant of a spring portion disposed on the case (for example, refer to PATENT DOCUMENT 1). According to the brushless motor, it is possible to prevent a large stress from acting on the resolver stator by the spring action of the spring portion.

In another of the brushless motors, a projection portion disposed on the resolver stator is engaged with an adjustment screw rotatably disposed on a bracket, and an angle adjustment of the resolver stator is performed by controlling the rotation amount of the adjustment screw (for example, refer to PATENT DOCUMENT 2).

Note that, in the brushless motors as mentioned above, the resolver stator is fixed on the inside (housing side) of the bracket covering an opening of the housing. Further, in the brushless motors, a signal lines (lead line) for leading signals from the resolver stator are brought out to the outside of the bracket, and then are connected to terminals disposed on the bracket side. The terminals are connected to ports of a coupler connected to the other control unit or the like.

PATENT DOCUMENT 1: Japanese Patent Application, First Publication No. 2003-23761

PATENT DOCUMENT 2: Japanese Patent Application, First Publication No. 2003-32989

### DISCLOSURE OF THE INVENTION

Problems to be Solved by the Invention

However, in this type of brushless motor, since the signal lines must be wired between the resolver stator and the bracket, the wiring of the signal lines becomes complex. Further, in order to wire the signal lines, the strength of the signal line must be high. Furthermore, if the signal lines are thick, it is hard to locate the signal lines.

In addition, in order to maintain the high accuracy of angle detection of the resolver, after installation of the resolver stator, the angle of the resolver stator must be adjusted while circumferentially moving the resolver stator. However, since the signal line is located between the resolver stator and the bracket, it is hard to adjust the angle of the resolver stator due to the elastic force of the signal line.

The present invention was conceived in view of the above-described circumstances, and it is an object of the present invention to provide a brushless motor in which it is easy to install the resolver stator, and which possesses higher reliability.

Means for Solving the Problem

The present invention provides a brushless motor including: a housing; a bracket which covers over an opening of the housing; a resolver case which houses a resolver stator of a resolver, and which is attached to the bracket; claw portions which are respectively provided with adjusting claws extending along a direction substantially parallel to an axis of a rotor, and which are provided at the resolver case; and a resolver terminals for acquiring signals from the resolver stator, which are provided at the resolver case, wherein a through-holes into which the claw portions are respectively inserted are formed in the bracket.

In this brushless motor, after installation of the bracket on the housing, adjustment of the location of the resolver stator is performed using the adjusting claw which is allowed to pass through the through-hole formed in the bracket.

In the brushless motor of the present invention, it is arranged such that an engaging claws extending in the circumferential direction be respectively provided at the claw portions, and the bracket include a first through-holes into which the claw portions are respectively inserted, a pedestal on which the engaging claws of the claw portions respectively inserted into the first through-holes is fixed, a second through-hole into which the resolver terminals are inserted, and terminal ends to which the resolver terminals inserted into the second through-hole are respectively connected.

In this brushless motor, the claw portion of the resolver case is inserted into the first through-hole, and the resolver terminal is inserted into the second through-hole. Further, after adjusting of the resolver using the adjusting claw, the engaging claw is held on the pedestal, and the resolver terminal is connected to the terminal of the bracket side. That is, since this brushless motor differs from the conventional brushless motor, it is unnecessary to locate a signal line for acquiring signals from the resolver between the resolver stator and the bracket.

In the brushless motor of the present invention, it is arranged such that each of the first through-holes and the second through-hole be an elongated hole extending along the circumferential direction of the bracket.

In this brushless motor, since each of the first through-hole and the second through-hole is an elongated hole extending along the circumferential direction of the bracket, it is possible to move the resolver stator and the resolver case along the circumferential direction in a state where the engaging claw and the resolver terminal are respectively inserted into the first through-hole and the second through-hole.

In the brushless motor of the present invention, it is arranged such that the width along the circumferential direction of a part of the terminal to which the resolver terminal is connected be larger than the width along the circumferential direction of the resolver terminal, and be smaller than the length along the circumferential direction of the first through-hole.

In this brushless motor, since the width of the part of the terminal to which the resolver terminal is contacted is large enough, when the resolver stator is moved along the circumferential direction in order to perform an angle adjustment, it is possible to maintain a state where the terminal is contacted to the resolver terminal.

Advantageous Effects of the Invention

According to the present invention, since the claw portion which passes through the bracket is provided at the resolver case, after installation of the bracket to the housing using the claw portion, the location adjustment of the resolver can be performed. Therefore, it is possible to adjust the location of the resolver easily, thus it is possible to increase the detection accuracy of the resolver. Further, the resolver terminal (an output terminal of the resolver stator) is connected to the terminal which is provided at the bracket, accordingly the signal line which connects the resolver terminal to the terminal is eliminated. As a result, the number of installation processes can be reduced, and it is possible to reduce costs. In addition, since it is unnecessary to consider the strength and the layout of the signal line, the reliability can be increased.

### BRIEF DESCRIPTION OF THE DRAWINGS

FIG. 1 is a sectional view showing an embodiment of a brushless motor of the present invention.

FIG. 2 is a view showing the bracket while looking at the bracket along a direction of arrow A in FIG. 1, and shows the bracket before installation of a resolver case to the bracket.

FIG. 3 is a perspective view showing a part of a plate.

FIG. 4 is a top plan view showing a resolver stator and the resolver case.

FIG. 5 is a sectional view taken along a line V-V in FIG. 4.

FIG. 6 is a view showing the bracket while looking at the bracket along a direction of arrow A in FIG. 1.

FIG. 7 is an enlarged view showing a part of FIG. 6, and shows a state where the resolver case is temporarily attached to the bracket.

### DESCRIPTION OF THE REFERENCE SYMBOLS

1 . . . brushless motor, 2 . . . housing, 2a . . . opening, 4 . . . bracket, 32 . . . pedestal, 33 . . . first through-hole, 36 . . . second through-hole, 37 . . . connection portion (terminal), 38 . . . terminal, 42 . . . resolver stator, 43 . . . resolver case, 46 . . . resolver terminal, 51 . . . resolver claw portion (claw portion), 52 . . . adjusting claw, 53 . . . engaging claw

### BEST MODE FOR CARRYING OUT THE INVENTION

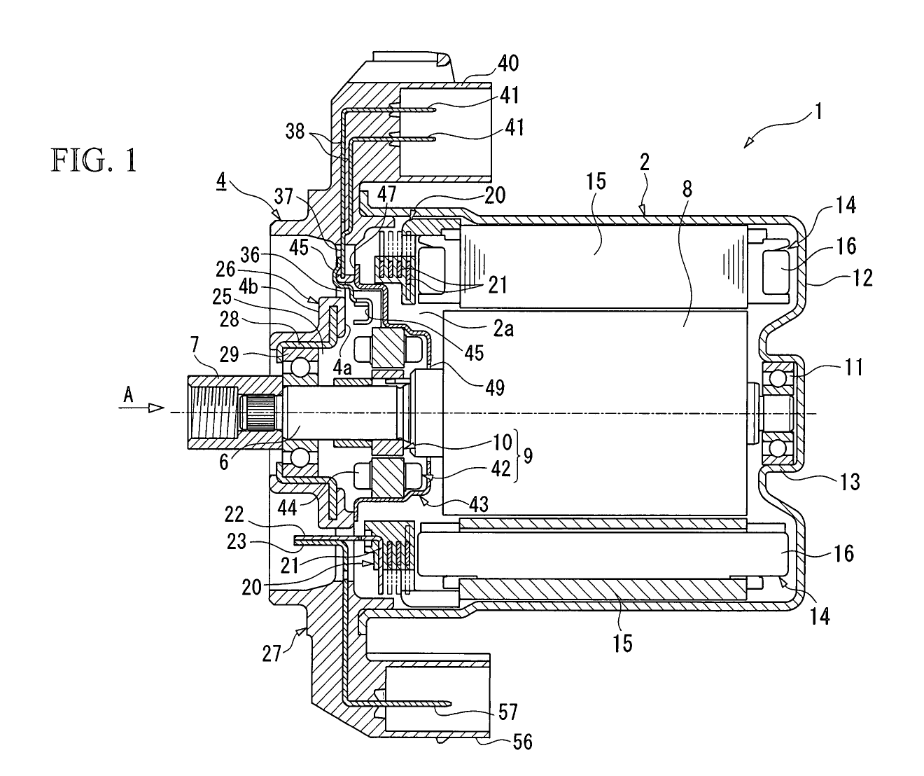

A best mode for carrying out the present invention will be explained with reference to figures. As shown in FIG. 1, in a brushless motor 1, a rotor 3 is inserted inside a housing 2 which is a cylindrical yoke having a bottom. A bracket 4 is attached to an opening 2a of the housing 2.

The rotor 3 has a rotation shaft 6. A joint 7 which is connected to a rotation shaft of another device is pressed into the tip end of the rotation shaft 6. Magnets 8 are fixed to the terminal of the rotation shaft 6. The polarity of each of the magnets 8 differs, and the magnets 8 are alternatively disposed around the rotation shaft 6. A resolver rotor 10 which constructs a resolver 9 for detection of the rotation position is fixed to a part of the rotation shaft 8 which is closer to the tip end of the rotation shaft 6 than the magnet 8. The terminal end of the rotation shaft 6 is rotatably supported by a bearing 11.

The bearing 11 is pushed into a recessed portion 13 which is formed at the center of a bottom portion of the housing 2. Cores 16 such as iron cores are disposed along an inner circumferential surface of the housing 2. Conductive wires 15 are respectively wound around the cores 16, thereby each of magnetic coils 14 is formed. The magnetic coils 14 are disposed inside the housing 2 so as to be placed opposite with respect to each of phases (U-phase, V-phase and W-phase) which turn on electricity. Note that the housing 2 and the magnetic coils 14 including the cores 16 form a stator of the brushless motor 1.

Terminal units 20 are disposed inside the housing 2 so as to be close to the opening 2a. A number of terminals 21 which are insulants are disposed on each of the terminal units 20. The terminals 21 are stacked in an axial direction so as to respectively interpose insulating layers between terminals 21. The wind beginning end and wind terminating end of the wire 15 of the magnetic coils 14 are respectively connected to the terminals 21. Further, terminal ends 22 which extend toward the tip end side of the rotation shaft 6 are respectively attached to each of the terminals 21. The terminal ends 22 passes through the bracket 4, and are respectively connected to each of terminals 23 at the outside of the bracket 4. The terminals 23 are fixed to the bracket 4.

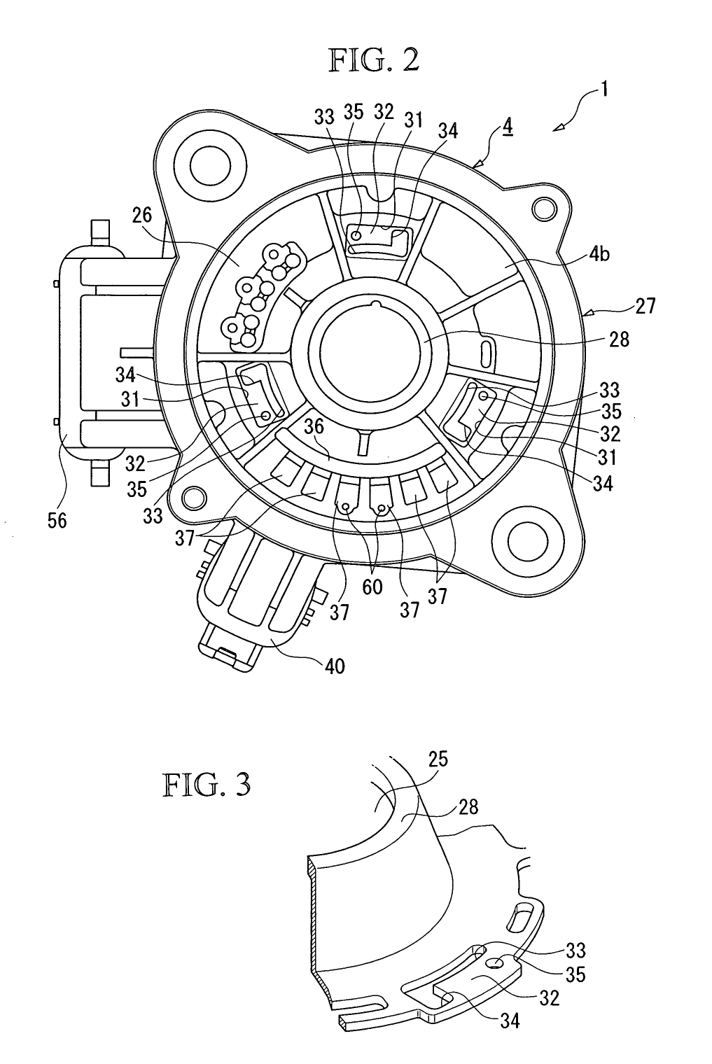

As shown in FIG. 1 and FIG. 2, the bracket 4 includes a base portion 26 like a substantially circular disc having an opening 25 which is formed in the center of the bracket 4. A side portion 27 of which the length along the axial direction is longer than the base portion 26 is disposed at an outer circumferential edge of the base portion 26. This bracket 4 is formed from insulant resin. A metal plate 28 is inserted into the inside of the opening 25 of the base portion 26. It is preferable that the bracket 4 made of polyphenylene sulphide (PPS) resin which is crystalline thermoplastic be used. However, another resin may be used.

The plate 28 is substantially formed like a ring, and is bent along the axial direction after a end portion located at an inner circumferential side protrudes to the opening 25 of the base portion 26. A bearing 29 is pushed into the inside of the bent portion of the plate 28. The bearing 29 rotatably supports the tip end of the rotor 3.

As shown in FIG. 2, three elongated holes 31 which pass through the base portion 26 from an inside surface 4a to an outside surface 4b of the bracket 4 are provided at the base portion. The elongated holes 31 are located at the base portion 26 centering around the rotation shaft 6 so as to separate each other at an angle of 120°. An outer circumferential edge portion (pedestals 32) of the plate 28 is exposed at the elongated holes 31. As shown in FIG. 3, each of the pedestals 32 is formed so that apart of the outer circumferential edge portion of the plate 28 extends outward in the radial direction. As shown in FIG. 2 and FIG. 3, first through-holes 33 which are an elongated holes extending along the circumferential direction are respectively formed in the pedestals 32. One end portion of each of the first through-holes 33 is extended outward in the radial direction. The extended portions 34 are respectively located at the pedestal 32 so as to separate each other at the angle of 120°. At each of the pedestals 32, recessed portions 35 are respectively formed so as to be exposed at each of the elongated holes 31. The recessed portions 35 are used for supporting the plate 28 by a molding die when the insert molding is performed.

As shown in FIG. 2, a second through-hole 36 which is an elongated hole extending along the circumferential direction is formed between the first through-holes 331 which are located side-by-side. The second through-hole 36 passes through the bracket 4 from the inside surface 4a to the outside surface 4b of the bracket 4. Six connection portions 37 are provided so as to be located from the second through-hole 36 toward an outer edge of the bracket 4. Each of the connection portions 37 is disposed at regular intervals along the circumferential direction in a fan-shaped area which is formed from one end of the second through-hole 36 to the other end of the second through-hole 36. That is, the connection portions 37 are arranged like an arc. As shown in FIG. 1, the connection portions 37 are respectively formed of one end portions of the terminals 38. The terminals 38 pass through the inside of the bracket 4, and are respectively connected to terminals 41 of the coupler 40 which is provided at the side portion 27. Recessed portions 60 which are respectively formed in the connection portions 37 are used when the insert molding is performed.

A stator (resolver stator) 42 of the resolver 9 and a resolver case 43 which houses the stator 42 are attached to the bracket 4.

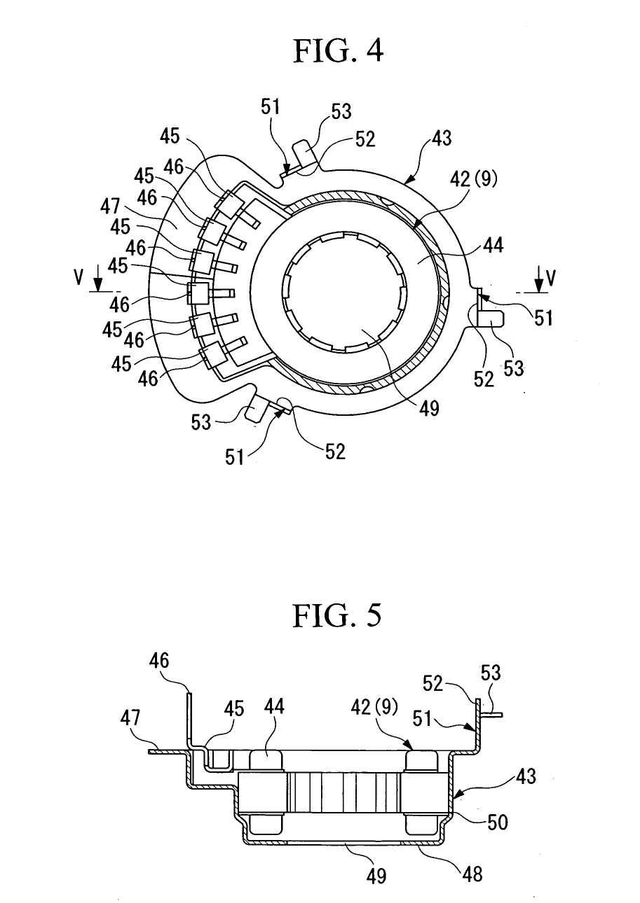

As shown in FIG. 4 and FIG. 5, the resolver stator 42 includes magnetizing coils 44 which are located so as to be circular. When the bracket 4 is installed in the housing 2, the resolver stator 10 (refer to FIG. 1) is disposed inside the magnetizing coils 44.

Wires of the magnetizing coils 44 are stator terminals 45. The stator terminals 45 are six conductive bodies which are located along the circumferential direction at regular intervals. Pin-shaped resolver terminals 46 are arranged so as to be standing on an outer edge portion of each of the stator terminals 45.

The resolver stator 42 described above is housed in the resolver case 43. The resolver case 43 is manufactured by casting in stages such as press working. An opening 49 is formed in the center of a bottom portion 48 of the resolver case 43, and the rotor 3 is inserted into the opening 49. A cylindrical side portion 50 which extends along the axial direction is formed at a circumferential edge portion of the bottom portion 48. A recessed portion which houses the resolver stator 42 is formed from the side portion 50 and the bottom portion 48. In addition, parts of an upper edge portion of the side portion 50 shown in FIG. 5 protrude, thereby resolver claw portions 51 are formed.

As shown in FIG. 4, the resolver claw portions 51 are respectively located so as to be separated from each other at the angle of 120°. An adjusting claw 52 which extends parallel to the axial direction and an engaging claw 53 which extends outward in the radial direction are provided at a tip end of each of the resolver claw portions 51.

Further, in the resolver case 43, a flange portion 47 is formed at a curved part along the stator terminal 45 of the resolver stator 42.

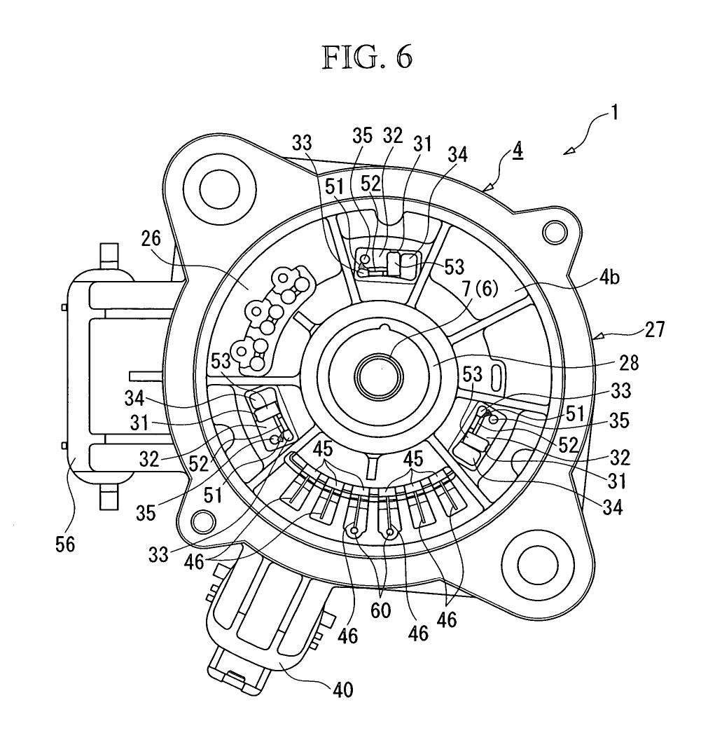

As shown in FIG. 6, when the resolver case is installed at the bracket 4, the resolver claw portions 51 respectively pass through the first through-holes 33 respectively formed in the pedestals 32, and the engaging portions 53 are respectively fixed to the pedestals 32. Also, each of the resolver terminals 46 passes through the second through-hole 36 and then the resolver terminals 46 are respectively bent toward the connection portions 37, and are respectively fixed to the connection portions 37. The resolver terminal 46 may be fixed to the connection portion 37 with arc-welding. However, the resolver terminal 46 may be fixed to the connection portion 37 with another method. At this time, the flange portion 47 contacts to the inside surface 4a of the bracket 4.

Herewith, the resolver case 43 can be rotationally moved in the circumferential direction by just the length of the first through-hole 33 while adjusting the installation angle of the resolver case 43. At this time, sometimes the resolver terminals 46 are rotationally moved in the circumferential direction by just the length of the first through-hole 33 with the resolver case 43. Thus, in order to ensure contacting of the resolver terminals 46 to the connection portions 37 in a case where the resolver terminals 46 has been rotationally moved, the width of the connection portion 37 in the circumferential direction is larger than the diameter of the resolver terminal 46, and is smaller than the length of the first through-hole 33 in the circumferential direction. In this embodiment, since the adjustable travel distance of the resolver case 43 is smaller than the length of the first through-hole 33, the width of the connection portion 37 is smaller than the length of the first through-hole 33. Because the distance between the magnetizing coils 44 of the resolver stator 42 is short, if the travel distance of the resolver case 43 is shorter than the length of the first through-hole 33, suitable signals can be obtained. Concretely, the width of the connection portion 37 is equivalent to an arc formed by an angle of 5° at the center of the bracket 4, that is, a size such that the connection portion 37 can be electrically connected to the resolver terminal 46 if the resolver stator 42 rotates at an angle of 5°. Note that, the width of the connection portion 37 in the circumferential direction is set based on the mechanical shape or the character of the resolver 9, and it is not necessary that the width of the connection portion 37 in the circumferential direction be equivalent to an arc formed by an angle of 5°.

In addition, as shown in FIG. 1, the terminals 23 connected to the above-mentioned terminal unit 20 are inserted in the side portion 27 of the bracket 4. The terminals 23 are respectively connected to terminals 57 of a coupler 56 located at the side portion 27. A power cable is connected to the coupler 56, and then electric power is supplied to the coupler 56 from a three-phase electric power source.

Next, assembling work of the brushless motor 1 will be explained.

Firstly, as shown in FIG. 1, the bearing 11 is pressed into the recessed portion 13 of the housing 2 so as to dispose the electromagnetic coils 14 which are formed by winding the wires 15 around the cores 16. Then, the terminal unit 20 is attached so as to contact the cores 16 of the electromagnetic coils 14 and drawn ends of the wires of the electromagnetic coils 14 are connected with the terminals 21.

Further, the rotor 3 is inserted into a space formed dividing inside the housing 2 with the electromagnetic coils 14 and the other end of the rotation shaft 6 is supported by the bearing 11.

On the other hand, the resolver stator 42 is attached to the bracket 4. That is to say, firstly, after housing the resolver stator 42 into the resolver case 43, the resolver case 43 is temporarily fixed to the bracket 4. When temporarily fixing, the resolver terminals 46 which extend from the stator terminals 45 penetrate through the second through-hole 36. At the same time, the resolver claw portions 51 respectively pass through the first through-holes 33. At this time, the engagement claws 53 are drawn out to the pedestals 32 through the extension portions 34 of one end side of the first through-holes 33.

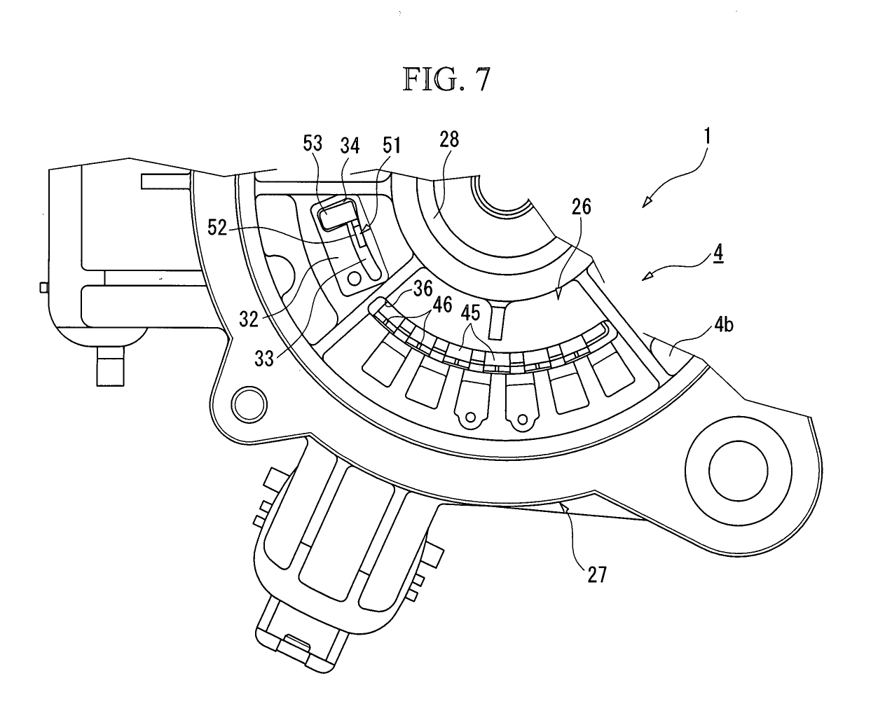

Further, by pushing the adjusting claws 52 along the circumferential direction so that the resolver case 43 is rotated in an anticlockwise direction (refer to FIG. 7), the engaging claws 53 are moved from the extension holes of the first through-holes 33 to the pedestals 32 which have no openings. As a result, the engaging claws 53 are engaged with the pedestals 32 along the axial direction and the resolver case 43 is temporarily fixed to the bracket 4.

As shown in FIG. 1, the bracket 4 to which the resolver case 43 is temporarily fixed is inserted into the opening 2a of the housing 2 so as to cover the opening 2a, and fixed by bolts. Therefore, the rotation shaft 6 of the rotor 3 passes through an opening 39 of the resolver case 43, the center of the resolver stator 42, and the opening 25 of the bracket 4, and the tip end of the rotation shaft 6 protrudes outward.

Next, the resolver stator 42 is moved along the circumferential direction by an automatic machine (not illustrated) and is the angle of the resolver stator 42 is adjusted, the resolver terminals 46 are welded to the connection portions 37, and the engagement claws 53 are welded to the pedestals 32.

Concretely, the automatic machine obtains an output of the resolver stator 42 from the resolver terminals 46. Further, the angle is adjusted so that the output of the resolver stator 42 shows a prescribed value by hooking the adjusting claws 52 extending along the axial direction of the resolver case 43 so as to rotate the resolver stator 42 with the resolver case 43 along the circumferential direction. After adjusting the angle of the resolver stator 42, the engaging claws 53 are welded to the pedestals 32. Furthermore, distal ends of the resolver terminals 46 are bent outward in the radial direction and are made to contact with the connection portions 37 of the bracket 4, and then the connection portions 37 are welded to the resolver terminals 46. As a result, the resolver case 43 is fixed to the bracket 4, and the output of the resolver stator 42 can be obtained from the coupler 40 through the resolver terminals 46 and the terminals 38.

According to this embodiment, when the resolver stator 42 is installed at the bracket 4, since the resolver terminals 46 are respectively welded to the connection portions 37 of the terminal 38 located on the side of the bracket 4, it eliminates the need for the conventional signal lines, accordingly the installation of the brushless motor becomes easy. Further, the durability in use can be increased. Furthermore, since the signal lines are eliminated, a brushless motor which stands a lot of noise can be obtained.

In the installation of the brushless motor, the resolver terminals 46 are moved in the circumferential direction while adjusting the angle of the resolver stator 42. Since the width of the connection portion 37 in the circumferential direction is sufficiently larger than the resolver terminal 46, the electric connection can be maintained while allowing the circumferential movement of the resolver terminals 46.

In addition, since the engaging claws 53 of the resolver case 43 are engaged with the metal plate 28 used to support the bearing, the supporting strength of the resolver case 43 is increased. Further, since the first through-holes 33 of the plate 28 are elongated holes, the resolver case 43 can be moved in the circumferential direction, and thus it is possible to adjust the angle of the resolver stator 42 easily. Furthermore, since each of the adjusting claws 52 is substantially parallel to the axial direction, it is possible to move the resolver case 43 in the circumferential direction easily. Therefore, after installation of the bracket 4 to the housing 2, the angle of the resolver stator 42 can be adjusted. As a result, the workability and the reliability of adjusting the angle of the resolver stator 42 are increased.

Moreover, since the resolver case 43 is fixed by welding the engaging claws 53 to the pedestals 32, fixing points of the resolver case 43 are larger than the case where the resolver case 43 is fixed by screw clamping, and thus the stability of the resolver case 43 is increased. As a result, the vibration property of the brushless motor 1 can be increased.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, the first through-holes 33 or the second through-hole 36 are not limited to the elongated holes. Instead of the adjusting claws 52 provided at the resolver case 43, it may be arranged such that the angle of the resolver case 43 be adjusted using the engaging claws 53.

### INDUSTRIAL APPLICABILITY

The present invention relates to a brushless motor including: a housing; a bracket which covers over an opening of the housing; a resolver case which houses a resolver stator of a resolver, and which is attached to the bracket; claw portions which are respectively provided with adjusting claws extending along a direction substantially parallel to an axis of a rotor, and which are provided at the resolver case; and a resolver terminals for acquiring signals from the resolver stator, which are provided at the resolver case, wherein a through-holes into which the claw portions are respectively inserted are formed in the bracket.

According to the brushless motor of the present invention, it is possible to adjust the location of the resolver easily, thus it is possible to increase the detection accuracy of the resolver. Further, the number of installation processes can be reduced, and it is possible to reduce costs. Furthermore, the reliability can be increased.

What is claimed is:

1. A brushless motor comprising:
a housing;
a bracket which covers over an opening of the housing;
a resolver case which houses a resolver stator of a resolver, and which is attached to the bracket;
claw portions which are respectively provided with adjusting claws extending along a direction substantially parallel to an axis of a rotor, and which are provided at the resolver case; and
a resolver terminals for acquiring signals from the resolver stator, which are provided at the resolver case, wherein
a through-holes into which the claw portions are respectively inserted are formed in the bracket.

2. The brushless motor according to claim 1, wherein
an engaging claws extending in the circumferential direction are respectively provided at the claw portions, and
the bracket comprises a first through-holes into which the claw portions are respectively inserted, a pedestal on which the engaging claws of the claw portions respectively inserted into the first through-holes is fixed, a second through-hole into which the resolver terminals are inserted, and terminal ends to which the resolver terminals inserted into the second through-hole are respectively connected.

3. The brushless motor according to claim 2, wherein
each of the first through-holes and the second through-hole is an elongated hole extending along the circumferential direction of the bracket.

4. The brushless motor according to claim 3, wherein
a width along the circumferential direction of a part of the terminal to which the resolver terminal is connected is larger than a width along the circumferential direction of the resolver terminal, and is smaller than the length along circumferential direction of the first through-hole.
